(19) United States
(12) Patent Application Publication
(10) Pub. No.: US 2026/0318611 A1
(43) Pub. Date: Oct. 15, 2026

(54) OSCILLATING HEAT PIPE WITH TESLA VALVE FEATURE

(71) Applicant: Raytheon Company, Arlington, VA (US)

(72) Inventors: Abbas A. Alahyari, Glastonbury, CT (US); Miad Yazdani, South Windsor, CT (US); Jason G. Milne, El Segundo, CA (US); Jason Michael Kehl, Inglewood, CA (US)

(21) Appl. No.: 19/174,392

(22) Filed: Apr. 9, 2025

(51) Int. Cl. F28D 15/02; F28D 15/06; F16K 15/00

(52) U.S. Cl. CPC F28D 15/0266; F28D 15/06; F16K 15/00

(57) ABSTRACT

An oscillating heat pipe includes an evaporator section, a condenser section, and a plurality of fluid channels extending between the evaporator section and the condenser section having a volume of heat transfer fluid disposed therein. The plurality of fluid channels are arranged in one or more closed fluid loops. Two or more fixed-geometry check valves are connected to a closed fluid loop of the one or more closed fluid loops. Two fixed-geometry check valves of the two or more fixed geometry check valves are positioned in opposing directions relative to a flow direction of the heat transfer fluid through the fluid loop.

### BACKGROUND

Exemplary embodiments pertain to the art of thermal energy removal from, for example, electronics, and more particularly to oscillating heat pipe configurations for removal of such thermal energy.

Oscillating heat pipes typically include two main sections, a condenser section and an evaporator section that are interconnected by looping channels. The channels are filled with a two-phase mixture, which acts as the heat transfer medium for the system. Instabilities caused by the intermittent evaporation and condensation of working fluid transfers the vapor from the evaporator to condenser and return liquid from condenser back to the evaporator section.

In larger, multiple loop oscillating heat pipes, bulk circulatory motion of the fluid can impede the oscillating behavior and degrade heat spreading performance. Break-up of the oscillating heat pipe into multiple smaller oscillating heat pipes results in a need for multiple filling ports and increases fabrication complexity and difficulty.

### BRIEF DESCRIPTION

In one exemplary embodiment, an oscillating heat pipe includes an evaporator section, a condenser section, and a plurality of fluid channels extending between the evaporator section and the condenser section having a volume of heat transfer fluid disposed therein. The plurality of fluid channels are arranged in one or more closed fluid loops. Two or more fixed-geometry check valves are connected to a closed fluid loop of the one or more closed fluid loops. Two fixed-geometry check valves of the two or more fixed geometry check valves are positioned in opposing directions relative to a flow direction of the heat transfer fluid through the fluid loop.

Additionally or alternatively, in this or other embodiments the two or more fixed-geometry check valves are positioned at the condenser section.

Additionally or alternatively, in this or other embodiments the two or more fixed-geometry check valves are each positioned between the evaporator section and the condenser section.

Additionally or alternatively, in this or other embodiments the two or more fixed-geometry check valves are configured to operate passively to provide no resistance to the flow of fluid along the fluid loop in a first direction, and impede the flow of fluid along the fluid loop in a second direction.

Additionally or alternatively, in this or other embodiments the evaporator section is positioned at a first end of the oscillating heat pipe, and the condenser section is disposed at a second end of the oscillating heat pipe opposite the first end.

Additionally or alternatively, in this or other embodiments the condenser section surrounds the evaporator section.

Additionally or alternatively, in this or other embodiments the two or more fixed-geometry check valves are positioned along non-adjacent fluid channels of the fluid loop.

Additionally or alternatively, in this or other embodiments at least one fixed-geometry check valve of the two or more fixed-geometry check valves is configured as an oblique connection between two adjacent fluid channels of the plurality of fluid channels.

In another exemplary embodiment, a thermal energy dissipation system includes a component and an oscillating heat pipe positioned at the component configured to remove thermal energy from the component. The oscillating heat pipe includes an evaporator section, a condenser section, and a plurality of fluid channels extending between the evaporator section and the condenser section having a volume of heat transfer fluid disposed therein. The plurality of fluid channels are arranged in one or more closed fluid loops. Two or more fixed-geometry check valves are connected to a closed fluid loop of the one or more closed fluid loops. Two fixed-geometry check valves of the two or more fixed geometry check valves are positioned in opposing directions relative to a flow direction of the heat transfer fluid through the fluid loop.

Additionally or alternatively, in this or other embodiments the two or more fixed-geometry check valves are positioned at the condenser section.

Additionally or alternatively, in this or other embodiments the two or more fixed-geometry check valves are each positioned between the evaporator section and the condenser section.

Additionally or alternatively, in this or other embodiments the two or more fixed-geometry check valves are configured to operate passively to provide no resistance to the flow of fluid along the fluid loop in a first direction, and impede the flow of fluid along the fluid loop in a second direction.

Additionally or alternatively, in this or other embodiments the evaporator section is positioned at a first end of the oscillating heat pipe, and the condenser section is disposed at a second end of the oscillating heat pipe opposite the first end.

Additionally or alternatively, in this or other embodiments the condenser section surrounds the evaporator section.

Additionally or alternatively, in this or other embodiments the two or more fixed-geometry check valves are positioned along non-adjacent fluid channels of the fluid loop.

Additionally or alternatively, in this or other embodiments at least one fixed-geometry check valve of the two or more fixed-geometry check valves is configured as an oblique connection between two adjacent fluid channels of the plurality of fluid channels.

In yet another exemplary embodiment. a method of transferring thermal energy from a component includes thermally connecting an oscillating heat pipe to the component. The oscillating heat pipe includes an evaporator section, a condenser section, and a plurality of fluid channels extending between the evaporator section and the condenser section having a volume of heat transfer fluid disposed therein. The plurality of fluid channels are arranged in one or more closed fluid loops. Two or more fixed-geometry check valves are connected to a closed fluid loop of the one or more closed fluid loops. Two fixed-geometry check valves of the two or more fixed geometry check valves are positioned in opposing directions relative to a flow direction of the heat transfer fluid through the fluid loop. A heat load is applied to the component, and the thermal energy is transferred to the condenser section via the plurality of fluid channels.

Additionally or alternatively, in this or other embodiments the thermal energy is transferred to one or more heat sinks at the condenser section.

Additionally or alternatively, in this or other embodiments the fixed-geometry check valves are configured to operate passively to provide no resistance to the flow of fluid along the fluid loop in a first direction, and impede the flow of fluid along the fluid loop in a second direction.

Additionally or alternatively, in this or other embodiments the two or more fixed-geometry check valves are positioned at the condenser section.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a thermal energy dissipation system;

FIG. 2 is a schematic illustration of an exemplary embodiment of an oscillating heat pipe of a thermal energy dissipation system;

FIG. 3 is a schematic illustration of another exemplary embodiment of an oscillating heat pipe of a thermal energy dissipation system;

FIG. 4A is a first schematic illustration of an embodiment of a fixed-geometry check valve of an oscillating heat pipe;

FIG. 4B is a second schematic illustration of an embodiment of a fixed-geometry check valve of an oscillating heat pipe;

FIG. 5 is a schematic illustration of another embodiment of a fixed-geometry check valve of an oscillating heat pipe; and

FIG. 6 is a schematic illustration of yet another embodiment of a fixed-geometry check valve of an oscillating heat pipe.

### DETAILED DESCRIPTION

A detailed description of one or more embodiments of the disclosed apparatus and method are presented herein by way of exemplification and not limitation with reference to the Figures.

Illustrated in FIG. 1 is an exemplary embodiment of an assembly 10. The assembly 10 includes a component 12, for example, an airfoil or control surface or other component of an aerospace system. A heat exchanger 16 is operably connected to the component 12 to remove thermal energy generated by, for example, a high speed flow 13 across the component 12 and/or the heat exchanger to thereby cool the heat generating component 12. In some embodiments, the heat exchanger 16 is embedded in the component 12, at least partially defining an outer surface 14 of the component 12.

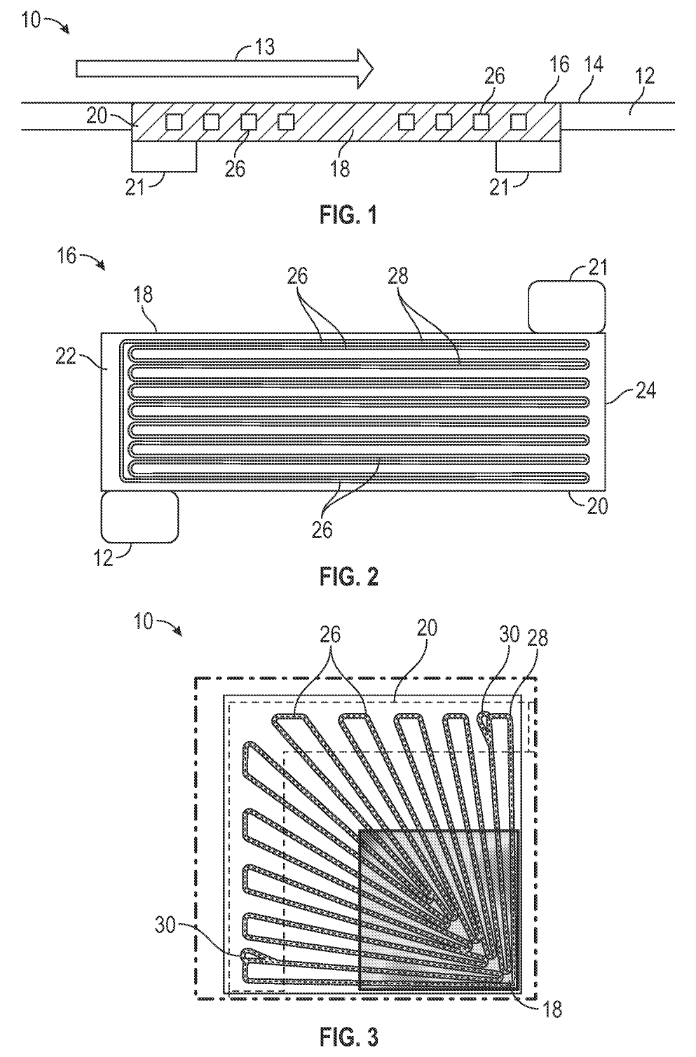

Referring now to FIG. 2, the heat exchanger is configured as an oscillating heat pipe (OHP) 16. The OHP 16 includes an evaporator section 18 at which thermal energy is absorbed from the component 12, and a condenser section 20 at which the thermal energy is rejected from the OHP 16 to, for example, one or more heat sinks 21. In the embodiment of FIG. 2, the OHP 16 is configured as a linear OHP 16, in which the condenser section 20 is located at a first end 22 of the OHP 16, and the evaporator section 18 is located at a second end 24 of the OHP 16, opposite the first end 22.

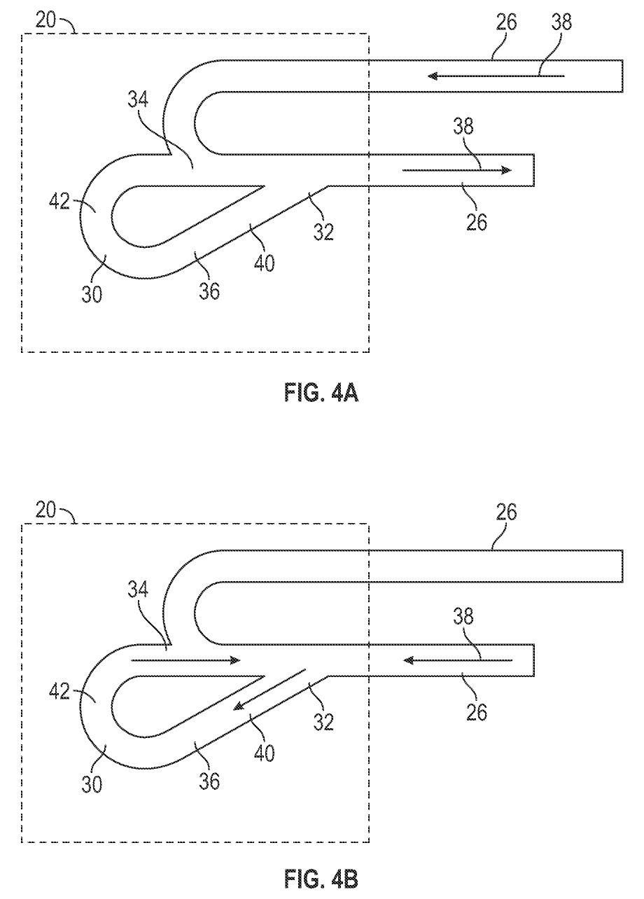

In other embodiments, such as shown in FIG. 3 for example, the OHP 16 is configured as a radial OHP 16, where in the condenser section 20 surrounds the evaporator section 18. A plurality of fluid channels 26 extend substantially radially outwardly from the evaporator section 18 to the condenser section 20. In some embodiments, the plurality of fluid channels 26 are arranged into one or more closed fluid loops 28 that are arranged between the evaporator section 18 and the condenser section 20. The fluid channels 26 are initially at least partially filled with a volume of heat transfer fluid. As illustrated in FIG. 3, one or more fixed-geometry check valves 30, also referred to as Tesla valves, are disposed along the fluid loop 28. As shown in FIGS. 4A and 4B, the fixed-geometry check valve 30 includes a first valve end 32 connected to the fluid channel 26 and a second valve end 34 connected to the fluid channel 26. At opposing ends of the fixed-geometry check valve 30, with a valve conduit 36 extending between the first valve end 32 and the second valve end 34. The valve conduit 36 is shaped and configured to operate passively to provide virtually no resistance to the flow of fluid 38 along the fluid channel 26 in a first direction as shown in FIG. 4A, while impeding the flow of fluid 38 along the fluid channel 26 in a second direction as shown in FIG. 4B. In some embodiments, the valve conduit 36 includes a linear first portion 40 extending from the first valve end 32 and a bowed second portion 42 extending from the linear first portion 40 to the second valve end 34. In some embodiments, the valve conduit 36 may also include internal features such as, for example, enlargements, recesses, projections, baffles, or buckets, to provide a desired performance of the fixed-geometry check valve 30.

Referring again to FIG. 3, the two fixed-geometry check valves 30 are positioned in opposing directions relative to each other and to flow direction through the fluid loop 28. This opposing configuration and arrangement prevents undesired bulk circulatory motion of the flow of fluid 38 through the fluid loop 28. In some embodiments, such as illustrated in FIG. 3, the fixed-geometry check valves 30 are positioned at opposing ends of the fluid loop 28, maximizing a spacing between the fixed-geometry check valves 30. While the fixed-geometry check valves 30 are illustrated in the context of a radial OHP 16 in FIG. 3, one skilled in the art will readily appreciate that fixed-geometry check valves 30 may be similarly utilized in other OHP 16 configurations, such as the linear OHP 16 of FIG. 2.

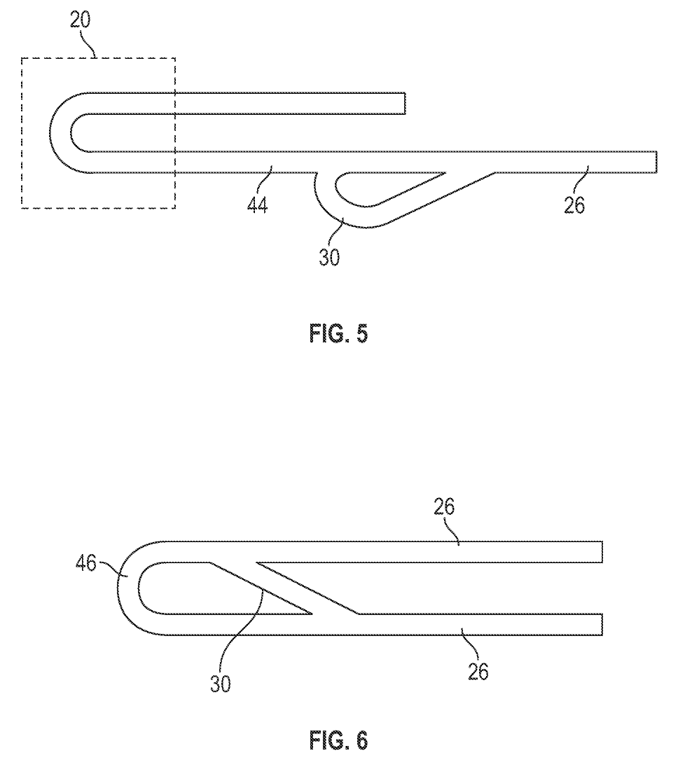

Referring again to FIG. 4A, in some embodiments the fixed-geometry check valves 30 are disposed along the fluid channels 26 at the condenser end 20. This position of the fixed-geometry check valves 30, however, is merely exemplary. In another embodiment, such as illustrated in FIG. 5, the fixed-geometry check valves 30 are disposed in a channel body 44 between the condenser section 20 and the evaporator section 18. In another embodiment, illustrated in FIG. 6, the fixed-geometry check valve 30 is embedded in the fluid loop 28 at an end turn 46 of the fluid loop 28 between two adjacent fluid channels 26, with an oblique connector of the fixed-geometry check valve 30 connecting the two adjacent fluid channels 26.

The inclusion of the fixed-geometry check valves 30 in the OHP 16 improves and stabilizes performance of the OHP 16 by preventing undesired bulk circulatory motion of the flow of fluid. Additionally, such an OHP 16 is easier to fabricate and fill, when compared to OHP’s having multiple smaller fluid loops.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An oscillating heat pipe, comprising:
an evaporator section;
a condenser section; and
a plurality of fluid channels extending between the evaporator section and the condenser section having a volume of heat transfer fluid disposed therein, the plurality of fluid channels arranged in one or more closed fluid loops; and
two or more fixed-geometry check valves connected to a closed fluid loop of the one or more closed fluid loops;
wherein two fixed-geometry check valves of the two or more fixed geometry check valves are positioned in opposing directions relative to a flow direction of the heat transfer fluid through the fluid loop.

2. The oscillating heat pipe of claim 1, wherein the two or more fixed-geometry check valves are disposed at the condenser section.

3. The oscillating heat pipe of claim 1, wherein the two or more fixed-geometry check valves are each disposed between the evaporator section and the condenser section.

4. The oscillating heat pipe of claim 1, wherein the two or more fixed-geometry check valves are configured to operate passively to provide no resistance to the flow of fluid along the fluid loop in a first direction, and impede the flow of fluid along the fluid loop in a second direction.

5. The oscillating heat pipe of claim 1, wherein the evaporator section is disposed at a first end of the oscillating heat pipe, and the condenser section is disposed at a second end of the oscillating heat pipe opposite the first end.

6. The oscillating heat pipe of claim 1, wherein the condenser section surrounds the evaporator section.

7. The oscillating heat pipe of claim 1, wherein the two or more fixed-geometry check valves are disposed along non-adjacent fluid channels of the fluid loop.

8. The oscillating heat pipe of claim 1, wherein at least one fixed-geometry check valve of the two or more fixed-geometry check valves is configured as an oblique connection between two adjacent fluid channels of the plurality of fluid channels.

9. A thermal energy dissipation system, comprising:
a component; and
an oscillating heat pipe disposed at the component configured to remove thermal energy from the component, the oscillating heat pipe including:
an evaporator section;
a condenser section; and
a plurality of fluid channels extending between the evaporator section and the condenser section having a volume of heat transfer fluid disposed therein, the plurality of fluid channels arranged in one or more closed fluid loops; and
two or more fixed-geometry check valves connected to a closed fluid loop of the one or more closed fluid loops;
wherein two fixed-geometry check valves of the two or more fixed geometry check valves are positioned in opposing directions relative to a flow direction of the heat transfer fluid through the fluid loop.

10. The thermal energy dissipation system of claim 9, wherein the two or more fixed-geometry check valves are disposed at the condenser section.

11. The thermal energy dissipation system of claim 9, wherein the two or more fixed-geometry check valves are each disposed between the evaporator section and the condenser section.

12. The thermal energy dissipation system of claim 9, wherein the two or more fixed-geometry check valves are configured to operate passively to provide no resistance to the flow of fluid along the fluid loop in a first direction, and impede the flow of fluid along the fluid loop in a second direction.

13. The thermal energy dissipation system of claim 9, wherein the evaporator section is disposed at a first end of the oscillating heat pipe, and the condenser section is disposed at a second end of the oscillating heat pipe opposite the first end.

14. The thermal energy dissipation system of claim 9, wherein the condenser section surrounds the evaporator section.

15. The thermal energy dissipation system of claim 9, wherein the two or more fixed-geometry check valves are disposed along non-adjacent fluid channels of the fluid loop.

16. The thermal energy dissipation system of claim 9, wherein at least one fixed-geometry check valve of the two or more fixed-geometry check valves is configured as an oblique connection between two adjacent fluid channels of the plurality of fluid channels.

17. A method of transferring thermal energy from a component, comprising:
thermally connecting an oscillating heat pipe to the component, the oscillating heat pipe including:
an evaporator section;
a condenser section; and
a plurality of fluid channels extending between the evaporator section and the condenser section having a volume of heat transfer fluid disposed therein, the plurality of fluid channels arranged in one or more closed fluid loops; and
two or more fixed-geometry check valves connected to a closed fluid loop of the one or more closed fluid loops;
wherein two fixed-geometry check valves of the two or more fixed geometry check valves are positioned in opposing directions relative to a flow direction of the heat transfer fluid through the fluid loop;
applying a heat load to the component; and
transferring the thermal energy to the condenser section via the plurality of fluid channels.

18. The method of claim 17, further comprising transferring the thermal energy to one or more heat sinks at the condenser section.

19. The method of claim 17, wherein the two or more fixed-geometry check valves are configured to operate passively to provide no resistance to the flow of fluid along the fluid loop in a first direction, and impede the flow of fluid along the fluid loop in a second direction.

20. The method of claim 17, wherein the two or more fixed-geometry check valves are disposed at the condenser section.
